(19) United States
(12) Patent Application Publication
(10) Pub. No.: US 2015/0023457 A1
(43) Pub. Date: Jan. 22, 2015

(54) SYSTEM AND METHOD FOR PROCESSING A SIGNAL RECEIVED FROM A MICROELECTROMECHANICAL SYSTEM

(71) Applicant: THALES, Neuilly Sur Seine (FR)

(72) Inventors: Paul DeLigny, Voisins Le Bretonneux (FR); Eddy Chollet, Valence Cedex (FR)

(21) Appl. No.: 13/857,310

(22) Filed: Apr. 5, 2013

(30) Foreign Application Priority Data
Apr. 6, 2012 (FR) 1201033

(51) Int. Cl. H04B 1/16; H04B 1/10

(52) U.S. Cl. CPC H04B 1/1638; H04B 1/1027; H04B 2001/1072
USPC 375/350

(57) ABSTRACT

System for processing a signal received from a microelectromechanical system, comprising means for sampling said received signal at a sampling frequency (Fₑ), means for frequency shifting a sampled signal by multiplying said sampled signal by a complex exponential function, means for low-pass filtering the frequency shifted signal, and means for sub-sampling said filtered signal.

The present invention relates to a device for processing a signal received from a microelectromechanical system. This received signal is characterized by a frequency bandwidth (±ΔF/2) and a central frequency (F₀) of the frequency band.

Microelectromechanical systems, also known by the acronym MEMS, are designed as oscillating (or vibrating) sensors which can be used to measure various physical quantities such as force, acceleration, angle of rotation or angular velocity, pressure, or temperature, as well as chemical quantities, for example in the detection of a substance, dosage or concentration.

In the prior art, a microelectromechanical system is composed of a resonator whose vibration at its resonant frequency is maintained by a continuous supply of energy. It also includes a detection circuit for shaping the signal, the output of the microelectromechanical system being an electrical signal whose amplitude and/or frequency contain the required measurement information. Additionally, in the case of a highly accurate microelectromechanical system (typically having an accuracy of more than 10⁻⁴ of the full scale), the amplitude and phase of the signal must be used. The signal output from the microelectromechanical system occupies a frequency band with a width of ±ΔF/2 around a central frequency F₀. According to Shannon's theorem, the sampling frequency of the signal must be greater than or equal to twice the maximum frequency contained in this signal, i.e.

$${F}_{e} \geq 2 ( {F}_{0} + \frac{Δ F}{2} ) .$$

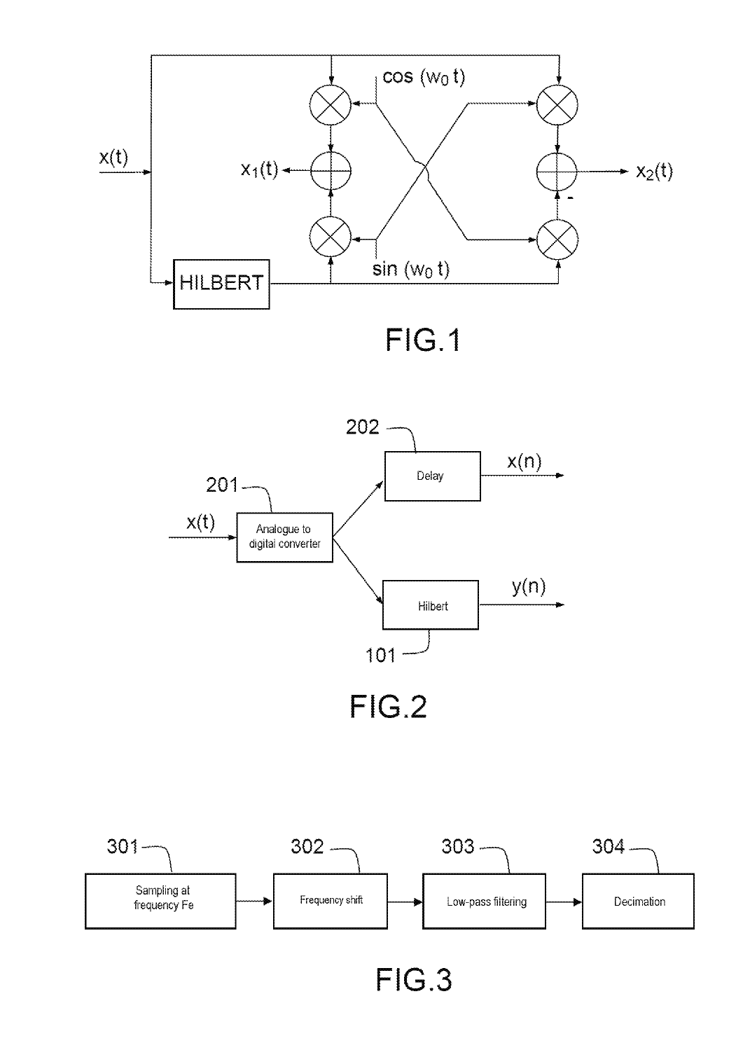

A system as shown in FIG. 1 for processing the signal x(t) received from a microelectromechanical system is known from the prior art. This system includes a Hilbert filter device 101. This type of filter requires a significant amount of computing power. It is a pure phase shifter which must retain the phase across the whole working band of the signal. On the other hand, the ripple in the filter band must be very low (for example, a typical ripple in the band is 10⁻⁷). The solution is therefore based on a filter of the finite impulse response type (also known by the acronym FIR). This filter has a very large number of coefficients and a very high computation rate. These filters typically have 128 coefficients, encoded on 35 signed bits. The typical range is 71 signed bits. The system also includes a device 102 for generating a sinusoidal signal with a frequency of F₀ and a device 103 for generating a sinusoidal signal with a frequency of F₀ in quadrature with the signal generated by the device 102. The system also includes signal multiplier devices 104 and signal subtractor devices 105. The output signals from the system, x₁(t) and x₂(t), are known as in-phase and quadrature signals, and they contain all the information in the baseband signal x(t). The signal x(t) can then be reconstituted exactly by using the following formula:

x(t)=x₁(t)cos(2πF₀t)+x₂(t)sin(2πF₀t)

In this solution, the analogue to digital converters are located upstream of the device.

A system as shown in FIG. 2 is also known from the prior art. This system includes an analogue to digital converter 201 which samples the signal at the frequency Fₑ. Like the system shown in FIG. 1, this system includes a Hilbert filter 101. This system also includes a delay device 202, which must have exactly the same characteristics, in terms of pure delay and band-edge phase shifts, as a Hilbert filter. In practice, the delay device uses a finite impulse response filter structure equivalent to that of the Hilbert filter. For high-accuracy applications, the implementation consists of two bandpass filters capable of filtering a signal at the sampling frequency Fₑ. In this system, x(n) corresponds to x₁(t) and y(n) corresponds to x₂(t).

The computing power available in the electronic circuitry associated with the microelectromechanical system is often limited. There is usually a programmable logic array, such as a programmable gate array, also known by the acronym FPGA, for “field programmable gate array”, or an application specific integrated circuit, known by the acronym ASIC. These components are often shared functionally between several microelectromechanical systems. The filters used in the systems known from the prior art, shown in FIGS. 1 and 2, are highly complex and therefore the requisite number of gates (in the case of an FPGA) or computing power (in the case of an ASIC) is high, as a result of which the volume, power consumption and heat dissipation of the signal processing devices known from the prior art are also high.

The object of the present invention is, notably, to overcome these problems by proposing a system for processing a signal received from a microelectromechanical system having lower computational complexity than that of the systems known from the prior art.

According to one aspect of the invention, a processing system for a signal received from a microelectromechanical system is proposed, comprising means 301 for sampling said received signal at a sampling frequency Fₑ, and means 302 for frequency shifting the sampled signal by multiplying the sampled signal by a complex exponential function. The system also comprises means 303 for low-pass filtering the frequency shifted signal and means 304 for sub-sampling the filtered signal.

Sub-sampling, or decimation, is a procedure whereby only a sample of a sampled signal, taken from N consecutive samples, is retained, where Nis the sub-sampling ratio.

The system can therefore be used to sample and extract a signal obtained from a microelectromechanical system. The output signal from the proposed system is equivalent to the signal obtained using a known system. The measurement information is then extracted in the same way, by amplitude, phase or frequency demodulation, depending on the manner in which the measurement of the microelectromechanical system is transmitted. The use of frequency transposition consists in multiplying the signal by k roots of unity (the coefficients are deduced from each other in an increasingly simple way as k becomes smaller), whereas the Hilbert FIR phase shifter is typically composed of two FIR bandpass filters with 128 coefficients.

Additionally, owing to the simplification of the filters in the system, the number of gates or the computing power required in the implementation of this system is lower than in the systems known from the prior art. Thus this system makes it possible to reduce the volume, electricity consumption and heat dissipation, and consequently the recurrent and non-recurrent cost of the system.

Another advantage of the system according to the invention is that the latency during computation is lower than in the systems described in the prior art.

The sampling frequency is determined, in the design of the system using the method, on the basis of factors including the frequency bandwidth ±ΔF/2 and the central frequency F₀ of said received signal. This sampling frequency is determined in such a way that k is substantially equal to Fₑ/F₀ (this frequency is chosen for reasons including the avoidance of the imperfections of the analogue anti-aliasing filter upstream of the analogue to digital converter. These imperfections are, in particular, the dissymmetry of gain relative to the central frequency F₀ and the ripple in the band). It is also determined in such a way that

$${F}_{e} > 2 ( {F}_{0} + \frac{Δ F}{2} ) ,$$

in order to satisfy Shannon's criterion. Finally, k is chosen such that Fₑ/k≧ΔF/2, thus allowing filtering and decimation by a factor k while satisfying Shannon's criterion after the spectral shift of −Fₑ/k.

Advantageously, said phase shift means are adapted to multiply said sampled signal by a complex exponential frequency function determined on the basis of said sampling frequency, of said frequency bandwidth ±ΔF/2 and of said central frequency F₀ of said received signal.

The complex exponential function is of the form e^{j2πF}^{_{d}}^{l}, and in this expression l denotes the index of the sampled signal respectively associated with a complex value of the expression and F_{d} denotes the desired frequency shift.

Advantageously, said filtering means are adapted to use a low-pass filter whose cut-off frequency is determined on the basis of said sampling frequency, of said frequency bandwidth ±ΔF/2, and of said central frequency F₀ of said received signal.

Advantageously, said filtering means are adapted to perform sub-sampling with a ratio determined on the basis of said sampling frequency, of said frequency bandwidth ±ΔF/2, and of said central frequency F₀ of said received signal.

Sub-sampling or decimation with a ratio of Nis a procedure whereby only one sample out of N consecutive samples of a sampled signal is retained.

Advantageously, the method for processing a signal received from a microelectromechanical system comprises a step of determining a sampling frequency, a step of sampling said received signal, this sampling being performed according to said sampling frequency, a step of frequency shift of said sampled signal by multiplying said received signal by a complex exponential function, a step of low-pass filtering of the frequency-shifted signal and a step of sub-sampling said filtered signal.

The invention will be more clearly understood and other advantages will become apparent in the light of the detailed description provided by way of non-limiting example and with the aid of the drawings, in which:

FIG. 1 shows a first system for processing a signal according to the prior art;

FIG. 2 shows a second system for processing a signal according to the prior art;

FIG. 3 shows a possible realisation of the system according to an aspect of the invention.

The system for processing a signal occupying a limited frequency band ±ΔF/2 about a central frequency F₀, as shown in FIG. 3, includes the following devices.

The sampling frequency is determined, during the design of the system using the method, on the basis of factors including the frequency bandwidth ±ΔF/2 and the central frequency F₀ of said received signal. This sampling frequency is determined in such a way that k is substantially equal to Fₑ/F₀ (this frequency is chosen for reasons including the avoidance of the imperfections of the anti-aliasing filter upstream of the analogue to digital converter. These imperfections are, in particular, the dissymmetry of gain relative to the central frequency F₀ and the ripple in the band. It is also determined in such a way that

$${F}_{e} > 2 ( {F}_{0} + \frac{Δ F}{2} ) ,$$

in order to satisfy Shannon's criterion. Finally, k is chosen such that Fₑ/k≧ΔF/2, thus allowing filtering and decimation by a factor k while satisfying Shannon's criterion after the spectral shift of −Fₑ/k.

The system also includes a sampling device 301 at the frequency Fe. This device is generally an analogue to digital converter.

The system also includes a frequency shift device 302. This frequency shift is performed by multiplying the samples indexed with “l” of the sampled signal by the complex value of the expression e^{j2π(F}^{ₑ}^{/k)l} respectively, in which expression l denotes the index of the sample signal respectively associated with a complex value of the expression. This multiplication will cause the sampled signal to be frequency shifted by Fₑ/k.

The system further comprises a low-pass filter device 303 in which the start of the attenuation band is fixed at Fₑ/k. The cut-off frequency is the frequency at which the output signal is attenuated by a fixed value which is generally 3 dB, this cut-off frequency being chosen to pass the working band of the shifted signal F₀−Fₑ/k±ΔF/2 and to avoid a dissymmetry which would be a source of rectification in the case of an accelerometer under vibration. For example, it is possible to use a low-pass filter with a constant ripple rate (also known as an equiripple filter) applied to each of the in-phase and quadrature signals.

The system further includes a decimation device 304 with a ratio k. The decimation consists in retaining only one sample out of kin the signal.

Since the signal resulting from the proposed processing is equivalent to the analytical signal that would have been obtained with the systems known from the prior art, particularly those using a Hilbert filter, the processing for extracting the information contained in the signal received from the microelectromechanical system is the same. In particular, the module and phase information is preserved. Thus, the measurement that has been made by the microelectromechanical system and that is contained in the amplitude, frequency or phase modulation of signal can be extracted from the samples of the complex signal obtained at the output of the system described in this invention.

Furthermore, the proposed solution makes it possible to replace two bandpass filters having a central frequency of F₀ with a single bandpass filter designed for a frequency of Fₑ/k. The number of logic gates required to construct this system is therefore 2 k times smaller than that required for the systems known from the prior art. Similarly, in the case of an embodiment in a dedicated circuit, the requisite computing power is divided by 2 k.

1. System for processing a signal received from a microelectromechanical system, comprising:
means for sampling said received signal at a sampling frequency (Fₑ);
means for frequency shifting said sampled signal by multiplying said sampled signal by a complex exponential function;
means for low-pass filtering the frequency shifted signal;
means for sub-sampling said filtered signal.

2. System for processing a signal according to claim 1, wherein said filtering means are adapted to use a low-pass filter whose cut-off frequency is determined on the basis of said sampling frequency, of said frequency bandwidth ±ΔF/2, and of said central frequency F₀ of said received signal.

3. System for processing a signal according to claim 1, wherein said frequency shift means are adapted to multiply said sampled signal by a complex exponential frequency function determined on the basis of said sampling frequency, of said frequency bandwidth ±ΔF/2, and of said central frequency F₀ of said received signal.

4. System for processing a signal according to claim 3, wherein said filtering means are adapted to use a low-pass filter whose cut-off frequency is determined on the basis of said sampling frequency, of said frequency bandwidth ±ΔF/2, and of said central frequency F₀ of said received signal.

5. System for processing a signal according to claim 1, wherein said decimation means are adapted to perform decimation with a ratio determined on the basis of said sampling frequency, of said frequency bandwidth ±ΔF/2, and of said central frequency F₀ of said received signal.

6. Method for processing a signal received from a microelectromechanical system, comprising:
a step of sampling said received signal, this sampling being performed according to said sampling frequency;
a step of frequency shifting said sampled signal by multiplying said sampled signal by a complex exponential function;
a step of low-pass filtering the frequency shifted signal;
a step of sub-sampling said filtered signal.
